(19) United States
(12) Patent Application Publication
(10) Pub. No.: US 2018/0107949 A1
(43) Pub. Date: Apr. 19, 2018

(54) METHODS, APPARATUSES AND SYSTEMS FOR PROCESSING AN ORDER

(71) Applicant: BOE TECHNOLOGY GROUP CO., LTD., Beijing (CN)

(72) Inventors: Junjie Zhao, Beijing (CN); Zhenpeng Guo, Beijing (CN); Junyuan Ren, Beijing (CN)

(21) Appl. No.: 15/526,892

(22) PCT Filed: May 31, 2016
(86) PCT No.: PCT/CN2016/084048

§ 371 Date: May 15, 2017

(30) Foreign Application Priority Data
Feb. 6, 2016 (CN) 201610083960.8
Apr. 5, 2016 (CN) 201610207627.3
May 12, 2016 (CN) PCT/CN2016/081860

(51) Int. Cl. G06Q 10/02; G06Q 20/32; H04W 4/02; H04W 4/12; G06Q 50/30

(52) U.S. Cl. CPC G06Q 10/02; G06Q 20/3223; G06Q 50/30; H04W 4/12; H04W 4/02

(57) ABSTRACT

The present disclosure discloses a method, apparatus and system for processing an order. The method for processing an order comprises: receiving first order information transmitted by a first terminal, wherein the first order information comprises riding information including third party user information; transmitting second order information to a second terminal, wherein the second order information comprises the riding information; and transmitting a notification message to a third terminal according to the third party user information, wherein the notification message comprises information of the second terminal.

### CROSS-REFERENCE TO RELATED APPLICATION(S)

The present application is a U.S. National Phase Application of PCT Application No. PCT/CN2016/084048, filed on May 31, 2016, entitled “METHODS, APPARATUSES AND SYSTEMS FOR PROCESSING AN ORDER,” which claims priorities to Chinese Patent Application No. CN201610083960.8, filed on Feb. 6, 2016, Chinese Patent Application No. CN201610207627.3, filed on Apr. 5, 2016 and PCT Application No. PCT/CN2016/081860, filed on May 12, 2016, all of which are incorporated herein by reference in their entireties.

### TECHNICAL FIELD

The present application relates to the field of computer technology, and more particularly, to methods, apparatuses and systems for processing an order.

### BACKGROUND

At present, in the field of taxi hailing, if a user needs to take a taxi, the user may take a taxi for himself/herself online using taxi-hailing software.

### SUMMARY

The embodiments of the present application provide a method for processing an order, comprising:

receiving first order information transmitted by a first terminal, wherein the first order information comprises riding information including third party user information;

transmitting second order information to a second terminal, wherein the second order information comprises the riding information; and

transmitting a notification message to a third terminal according to the third party user information, wherein the notification message comprises information of the second terminal.

In a possible implementation, in the method according to the embodiments of the present disclosure, before transmitting second order information to a second terminal, the method further comprises:

transmitting an order confirmation request to the third terminal according to the third party user information; and

receiving an order confirmation response returned by the third terminal.

In a possible implementation, in the method according to the embodiments of the present disclosure, the order confirmation response comprises: updated riding information.

In a possible implementation, in the method according to the embodiments of the present disclosure, the first order information further comprises:

payment indication information for indicating that the first terminal or the third terminal pays for the order.

In a possible implementation, in the method according to the embodiments of the present disclosure, the method further comprises:

transmitting position information of the second terminal and/or the third terminal to the first terminal.

The embodiments of the present application provide an ordering method, comprising:

transmitting, by a first terminal, first order information to a server, so that the server orders for a third terminal according to third party user information, wherein the first order information comprises riding information including the third party user information; and

receiving a response message returned by the server indicating that the ordering is successful.

In a possible implementation, in the method according to the embodiments of the present disclosure, the first order information further comprises:

payment indication information for indicating that the first terminal or the third terminal pays for an order.

The embodiments of the present application provide an ordering method, comprising:

receiving, by a third terminal, an order confirmation request transmitted by a server according to first order information, wherein the order confirmation request comprises riding information;

transmitting an order confirmation response to the server, so that the server transmits second order information to a second terminal; and

receiving a notification message returned by the server indicating that the ordering is successful.

In a possible implementation, in the method according to the embodiments of the present disclosure, the order confirmation response comprises: updated riding information.

The embodiments of the present application provide a server for processing an order, comprising:

a reception unit configured to receive first order information transmitted by a first terminal, wherein the first order information comprises riding information including third party user information; and

a transmission unit configured to transmit second order information to a second terminal, wherein the second order information comprises the riding information;

wherein the transmission unit is further configured to transmit a notification message to a third terminal according to the third party user information, wherein the notification message comprises information of the second terminal.

In a possible implementation, in the server according to the embodiments of the present disclosure,

the transmission unit is further configured to transmit an order confirmation request to the third terminal according to the third party user information; and

the reception unit is further configured to receive an order confirmation response returned by the third terminal.

In a possible implementation, in the server according to the embodiments of the present disclosure, the reception unit is further configured to receive the order confirmation response comprising updated riding information returned by the third terminal.

In a possible implementation, in the server according to the embodiments of the present disclosure, the reception unit is further configured to receive the first order information comprising payment indication information transmitted by the first terminal; and

the payment indication information is used to indicate that the first terminal or the third terminal pays for the order.

In a possible implementation, in the server according to the embodiments of the present disclosure, the transmission unit is further configured to transmit position information of the second terminal and/or the third terminal to the first terminal.

The embodiments of the present application provide a first terminal, comprising:

a transmission unit configured to transmit first order information to a server, so that the server orders for a third terminal according to third party user information, wherein the first order information comprises riding information including the third party user information; and

a reception unit configured to receive a response message returned by the server indicating that the ordering is successful.

In a possible implementation, in the terminal according to the embodiments of the present disclosure, the transmission unit is further configured to transmit the first order information comprising payment indication information to the server; and the payment indication information is used to indicate that the first terminal or the third terminal pays for an order.

The embodiments of the present application provide a third terminal, comprising:

a reception unit configured to receive an order confirmation request transmitted by a server according to first order information, wherein the order confirmation request comprises riding information; and

a transmission unit configured to transmit an order confirmation response to the server, so that the server transmits second order information to a second terminal;

wherein the reception unit is further configured to receive a notification message returned by the server indicating that the ordering is successful.

In a possible implementation, in the terminal according to the embodiments of the present disclosure, the transmission unit is further configured to transmit the order confirmation response comprising updated riding information to the server.

The embodiments of the present application provide a system for processing an order, comprising:

a server; a first terminal; a second terminal; and a third terminal,

wherein the first terminal is configured to transmit first order information to the server, wherein the first order information comprises riding information including third party user information,

the server is configured to receive the first order information transmitted by the first terminal; transmit second order information to the second terminal; receive a response message returned by the second terminal indicating that the order is accepted successfully; and transmit a notification message to the third terminal according to the third party user information, wherein the notification message comprises information of the second terminal,

the third terminal is configured to receive an order confirmation request comprising the riding information transmitted by the server according to the first order information; transmit an order confirmation response to the server; and receive a notification message returned by the server indicating that the ordering is successful, and

the second terminal is configured to receive the second order information transmitted by the server; and return the response message indicating that the order is accepted successfully to the server, so that the server returns the notification message indicating that the ordering is successful to the third terminal,

wherein the server transmits the second order information to the second terminal according to the riding information included in the first order information or according to the updated riding information in the order confirmation response transmitted by the third terminal.

### BRIEF DESCRIPTION OF THE DRAWINGS

The accompanying drawings described here are used to provide a further understanding of the present application and constitute a part of the present application, and the illustrative embodiments of the present application and the description thereof are intended to be illustrative of the present application and are not to be construed as improperly limiting the present application. In the accompanying drawings:

FIG. 1 is a structural diagram of a system for processing an order according to an embodiment of the present application;

FIG. 2 is a flowchart of processing an order according to an embodiment of the present application;

FIG. 3 is a flowchart of processing an order according to an embodiment of the present application;

FIG. 4 is a flowchart of processing an order according to an embodiment of the present application;

FIG. 5 is a flowchart of processing an order according to an embodiment of the present application;

FIG. 6 is a flowchart of processing an order according to an embodiment of the present application;

FIG. 7 is a structural diagram of a server for processing an order according to an embodiment of the present application;

FIG. 8 is a structural diagram of a terminal according to an embodiment of the present application; and

FIG. 9 is a structural diagram of a terminal according to an embodiment of the present application.

### DETAILED DESCRIPTION

In order to make the purposes, technical solutions and advantages of the present application more clear, the technical solutions of the present application will be described clearly and fully hereinafter with reference to specific embodiments of the present application and corresponding accompanying drawings. Obviously, the described embodiments are only a part of the embodiments of the present application, instead of all the embodiments. All other embodiments obtained by those of ordinary skill in the art based on the embodiments of the present application without making creative work are within the scope of the present application.

In the related art, when a rider is not convenient to take a taxi for himself/herself, there is no way for the rider to ask others online to call a taxi for the rider himself/herself. For example, in practical applications in which a vehicle is pre-ordered, there are cases that a son/daughter orders online for his/her parents, and his/her parents have a ride after confirming the order online etc. Others can only inform a taxi-hailing condition of the rider in an offline manner (for example, by making a call or through face-to-face communication). Thus, when the rider is not convenient to take a taxi for himself/herself, others cannot take a taxi online for the rider, which results in poor convenience of user operations.

In view of the above cases, the present application provides a system formed by a first terminal (referred to as UE1 hereinafter), a second terminal (referred to as UE2 hereinafter), a third terminal (referred to as UE3 hereinafter), and a server (referred to as SER hereinafter), so that when an ordering person is inconsistent with a rider, the ordering person can order for the rider online, so as to improve the convenience of user operations while enhancing the riding efficiency.

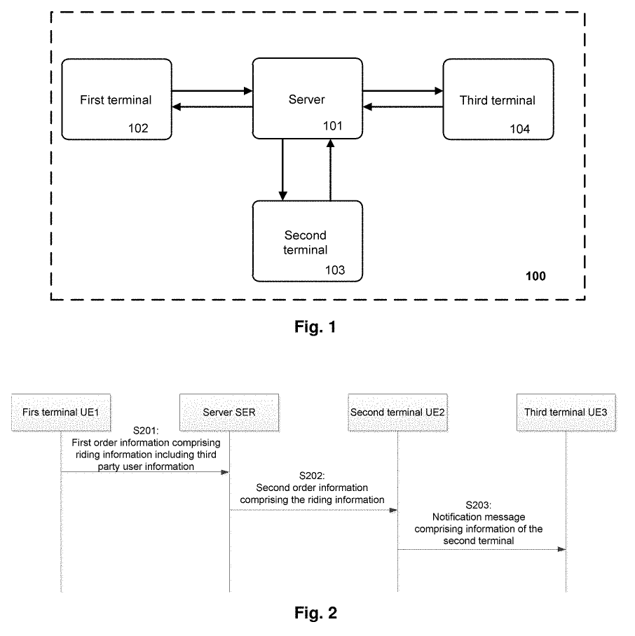

FIG. 1 is a structural diagram of a system 100 for processing an order according to an embodiment of the present application. The system 100 for processing an order comprises:

a server 101 for processing the order, a first terminal 102, a second terminal 103 and a third terminal 104.

The first terminal 102 is configured to transmit first order information to the server 101, wherein the first order information comprises riding information including third party user information.

The server 101 is configured to receive the first order information transmitted by the first terminal 102; transmit second order information to the second terminal 103; receive a response message returned by the second terminal 103 indicating that the order is accepted successfully; and transmit a notification message to the third terminal 104 according to the third party user information, wherein the notification message comprises information of the second terminal 103.

The third terminal 104 is configured to receive an order confirmation request comprising the riding information transmitted by the server 101 according to the first order information; transmit an order confirmation response to the server 101; and receive a notification message returned by the server 101 indicating that the ordering is successful.

The second terminal 103 is configured to receive the second order information transmitted by the server 101; and return the response message indicating that the order is accepted successfully to the server 101, so that the server 101 returns a notification message indicating that the order is accepted successfully to the third terminal 104.

The server 101 transmits the second order information to the second terminal 103 according to the riding information in the first order information or updated riding information in the order confirmation response transmitted by the third terminal 104.

Hereinafter, the method for processing an order according to the present application will be described through a process of interaction among the UE1, the UE2, the UE3, and the SER.

FIG. 2 is a method for processing an order according to an embodiment of the present disclosure. The method comprises the following steps.

In S201, the SER receives first order information transmitted by the UE1, wherein the first order information comprises riding information including third party user information.

In the embodiment of the present application, as the UE1 and UE2 do not have a capability of processing a large amount of data, the SER is required to assist in completing ordering. The UE1 transmits the first order information to the SER, wherein the first order information comprises the riding information including the third party user information.

In the embodiment of the present application, as an ordering person orders for others (i.e., a third party user), the riding information in the first order information transmitted by the UE1 to the SER further comprises the third party user information.

In the embodiment of the present application, in an implementation, when the UE1 transmits the first order information comprising the third party user information to the SER, the UE1 presents an ordering page to the user, which comprises promotion information for prompting the user to input riding information, and receives third party user information input by the user on the ordering page.

The riding information comprises riding position information and rider information. The riding position information is, for example, a start geographical riding position, an end geographical riding position (end geographical position), a riding route, a predetermined departure time etc. The rider information is the third party user information, for example an identity of the third party user information, such as a name, a nickname, a registered account, an identification number, a mobile communication number etc. of the third party user.

The first order information comprises, in addition to the riding information, information of the ordering user, that is, user information corresponding to the UE1, for example an identity of the user corresponding to the UE1, such as a name, a nickname, a registered account, an identification number, a mobile communication number etc. of the user corresponding to the UE1.

In S202, the SER transmits second order information to the UE2, wherein the second order information comprises the riding information.

In a practical application scenario, the UE2 is a second terminal corresponding to a driver, and in order to improve the ordering efficiency, it needs to firstly determine an appropriate UE2 before the SER transmits the second order information. Specifically, when determination of the UE2 is performed, the second order information may be transmitted to a limited number of UE2s or the second order information may be transmitted to a specified UE2.

In order to further improve the riding efficiency of the third party user, the second order information may be transmitted to a plurality of UE2s associated with the third party user information. For example, the second order information is transmitted to a plurality of UE2s at a predetermined distance (for example, 1 km) from the start geographical position of the rider, and if a number of the UE2s which agree to accept the order is more than one, the server may determine one of the UE2s according to driving record information of drivers. For example, the UE2 may be determined according to parameters which are determined according to an identity of a driver, such as an account integral, a number of completed orders, a favorable rate from ordering persons etc.

The second order information comprises the riding information in S201, to facilitate the UE2 to accept the order. Alternatively, when the UE2 receives the second order information, the UE2 may determine whether to return a first response message indicating that the order is accepted successfully to the SER with reference to the riding information (for example, the identity of the third party user, the start geographical riding position, the end geographical riding position, the predetermined departure time, the riding route etc.) in the second order information. If the UE2 rejects to accept the order, the SER may return to execute the step S202 (i.e., a step of transmitting a second ordering request to another UE2) after receiving a message indicating the order is rejected to be accepted which is returned by the UE2, or may transmit the second order information to another UE2 after the UE2 does not receive the first response message returned by the UE2 indicating that the order is accepted successfully within a certain period of time.

In S203, the SER transmits a notification message to the UE3 according to the third party user information, wherein the notification message comprises information of the UE2.

The information of the UE2 is driver information corresponding to the UE2, which comprises identity information of the driver such as a name, a nickname, a registered account, an identification number, a mobile phone number etc., may also comprise a model of a vehicle which is driven by the driver, a number of accepted orders etc., and may further comprise information such as a geographical position where the driver is located when the driver accepts the order, a predicted time when the driver arrives at the start geographical position of the rider etc. All information except for the identity in the driver information may be completely or partly carried by the first response message returned by the UE2 indicating that the order is accepted successfully, or may also be generated by the server according to the identity information of the driver.

Specifically, the notification message may be transmitted by the SER to the UE3 when the SER receives the first response message returned by a UE2 indicating that the order is accepted successfully for the first time, or when one of a plurality of UE2s is determined to transmit the second order information after the SER receives the first response message returned by each of the plurality of UE2s indicating that the order is accepted successfully.

The SER transmits the notification message to the UE3 according to the third party user information. Specifically, the SER may transmit the notification message to the UE3 via an online taxi-hailing software according to the identity of the third party user, may transmit the notification message to the UE3 via another communication soft software (such as WeChat) according to the identity of the third party user (or an identity of the third party user in the other communication software), or may transmit the notification message to the UE3 through a short message or a voice call according to the identity of the third party user (or a telephone number of the third party user).

With the method illustrated FIG. 2, the problem of failure in online ordering which results in poor convenience of operations when the ordering user orders a vehicle for others (i.e., the third party user) is solved through online interaction among the SER, the UE1, the UE2 and the UE3.

In order to improve the efficiency of acquiring the third party information by the UE1 and thereby improve the order processing efficiency of the present disclosure, the UE1 may specifically further acquire the third party user information by the following implementations.

In an implementation, the ordering user may directly input the third party user information on an ordering page under the promotion on the ordering page presented on the UE1, or may also directly invoke a historical record stored in the UE1, which comprises the third party user information.

Specifically, the identity in the third party user information may be acquired by invoking another application (such as a contact or a social application) to acquire the identity stored in other application.

Specifically, the start geographical position and the riding route in the riding information may be acquired by the ordering user inputting on the page. Considering that the ordering user may not be able to accurately input the start geographical position of the rider, the SER may also acquire the start geographical position of the rider through a positioning and mapping module of the SER or other servers according to the received identity of the third party user in the first order information transmitted by the UE1.

In S201, after the UE1 acquires information such as the start geographical position and the end geographical position, information in an electronic map, such as the start geographical position, the end geographical position, and the riding route may further be presented by the UE1 to the ordering user through an application page.

In order to prevent mis-operations of the ordering user, alternatively, after receiving the third party user information input by the ordering user on the ordering page and before transmitting the first order information, step S201 further comprises: determining whether the input third party user information is consistent with the ordering user information.

Specifically, the UE1 may further confirm whether the identity of the third party user is consistent with the identity of the ordering user after acquiring the information of the third party user, such as the identity, the start geographical position, the end geographical position etc. If so, the UE1 confirms that the ordering user does not order for others, and related promotion information is displayed on the ordering page to prompt the user of, for example, “the input information is your own information”. If not, the UE1 may transmit the first order information to the SER.

Also it may be confirmed by the server whether the third party user information is consistent with the ordering user information. For example, after the UE1 successfully transmits the first order information, it is confirmed by the SER whether the identity in the third party user information is consistent with the identity in the ordering user information. If not, S201 is executed, and if so, the promotion information is returned to the UE1.

In order to enable the ordering user to know whether the ordering is successful, alternatively, S203 further comprises the SER transmitting a second notification message to the UE1, wherein the second notification message comprises information of the UE2.

It should be considered that in a practical application scenario, when the ordering user orders for the third party user, the ordering user may erroneously input riding information of the third party user, such as the identity, the start geographical position, the end geographical position etc., or the riding information input by the ordering user for the third party user may no longer be accurate as a schedule of the third party user may change temporarily.

In order to ensure the accuracy of the third party user information, alternatively, before transmitting the second order information to the UE2, the method further comprises: the server transmitting an order confirmation request to the UE3 corresponding to the third party user according to the third party user information in the first order information.

Specifically, the SER transmits the order confirmation request to the UE3 after the SER receives a first ordering request transmitted by the UE1 and the SER transmits a second ordering request including information of a rider in the first ordering request to the UE2 after receiving an order confirmation response returned by the UE3.

The method for processing an order which further comprises a function of the UE3 confirming the order will be described by way of example of a process of entire interaction among the UE1, the UE2, the UE3 and the server.

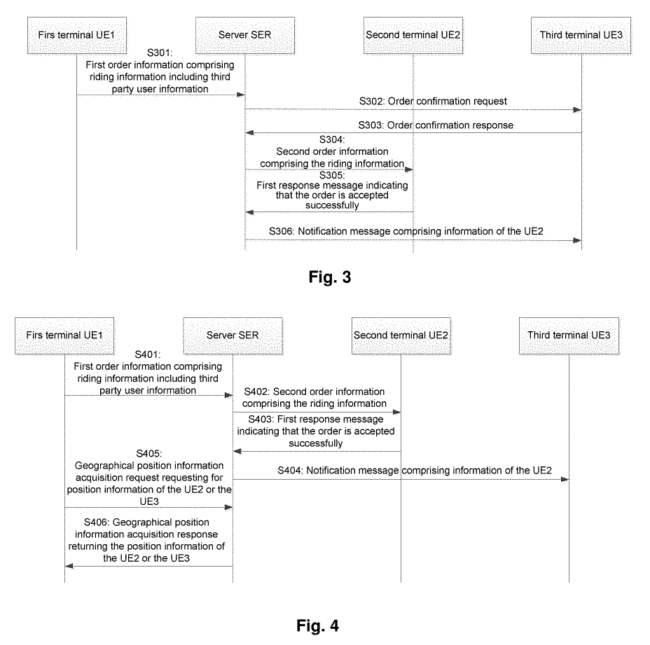

As shown in FIG. 3, a method for processing an order according to an embodiment of the present disclosure comprises the following steps.

In S301, the UE1 transmits first order information to the SER, wherein the first order information comprises riding information including third party user information.

In S302, the SER transmits an order confirmation request to the UE3.

Specifically, the order confirmation request transmitted by the SER to the UE3 may comprise information of a third party user, such as an identity, a start geographical position and an end geographical position, and may also comprise information such as a predetermined departure time, a riding route etc.

In S303, the UE3 transmits an order confirmation response to the SER.

Specifically, in response to the SER transmitting the order confirmation request to the UE3, the UE3 may receive the order confirmation request through an application on the UE3, or may receive the order confirmation request through a short message or a call etc. Therefore, the UE3 may generate an order confirmation message by clicking on a confirmation button on an interface of the application on the UE3, or may return the order confirmation response for confirmation by a rider answering a short message or answering a call etc.

In S304, the SER receives the order confirmation response transmitted by the UE3, and transmits second order information to the UE2, wherein the second order information comprises the riding information.

In S305, the UE2 returns a first response message indicating that the order is accepted successfully to the SER.

In S306, the SER transmits a notification message to the UE3, wherein the notification message comprises information of the UE2.

Further, it should be considered that if the information in the second ordering request is found to be erroneous when the UE3 generates an order confirmation response, it may directly lead to failure in ordering and then another ordering is required, which results in very low ordering efficiency.

In order to ensure the accuracy of the information of the rider while improving the efficiency of ordering for others, the embodiments of the present application may further comprise a method of updating the riding information by the UE3. In an implementation, in S303, the UE3 transmits an order confirmation response to the SER. The transmitted order confirmation response may carry updated riding information, for example, information such as an updated start geographical riding position, an updated end geographical riding position, an updated departure time etc., so that the SER can transmit a second ordering request to the UE2 according to the updated riding information. In another implementation, in S303, after the UE3 returns a message indicating that the order information is erroneous in the order confirmation response transmitted by the UE3 to the SER, the SER transmits a request for updating the information from the ordering user, and the UE3 returns the updated riding information to the SER.

In practical applications, when the ordering user orders for the third party user, especially when a young person orders for an elder person or a child, in order to ensure the safety of a travel, the UE1 corresponding to the ordering user also needs to acquire the position information of the third party user in the travel, and optionally, the position information of the UE3 in the embodiment of the present application.

Specifically, the geographical position information may be real-time positioning information, riding route information, or notification information indicating arrival at a destination at a certain point in time. In an implementation of the present embodiment, the geographical position information is presented in a text and voice form. In another implementation of the present embodiment, the geographical position information is presented in an electronic map interface in the application on the UE1, and specifically, through an electronic map interface in an application of the UE1 including the ordering page or through other applications on the UE1.

Specifically, the geographical position information of the UE2 (or UE3) received by the UE1 may be transmitted by the SER, or may be transmitted by the UE2 (or the UE3). In a case that the geographical position information is transmitted by the SER, the SER may identify the geographical position information of the UE2 (or the UE3) according to the identity of the UE2 (or the UE3), or may receive the geographical position information transmitted by the UE2 (or the UE3).

Specifically, the geographic position information may be actively acquired by the UE1 transmitting a request to the SER, or the geographical position information may be passively acquired by receiving a push from the SER, the UE2 or the UE3.

The process of the UE1 receiving the geographical position information of the UE2 (or the UE3) will be described by way of example of the UE1 actively acquiring the geographical position information of the UE3 from the SER.

As shown in FIG. 4, a method for processing an order according to an embodiment of the present disclosure comprises the following steps.

In S401, the UE1 transmits first order information to the SER, wherein the first order information comprises riding information including third party user information.

In S402, the SER receives the first order information transmitted by the UE1, and transmits second order information to the UE2, wherein the second order information comprises the riding information.

In S403, the UE2 returns a first response message indicating that the order is accepted successfully to the SER.

In S404, the SER transmits a notification message to the UE3, wherein the notification message comprises information of the UE2.

In S405, the UE1 transmits a geographical position information acquisition request for acquiring geographical position information of the UE2 or the UE3 to the SER.

Specifically, the UE1 transmits the geographical position information acquisition request for requesting the geographical position information of the UE2 or the UE3 to the SER. In an implementation, in response to the geographical position information acquisition request from the UE1, the SER returns position information of the UE3 when the SER receives the request, wherein the UE1 may transmit the geographical position information acquisition request many times at different times. In another implementation, the UE1 only needs to transmit the geographical position information acquisition request once, and the SER returns real-time position information and a riding route of the UE3 in the travel, and present the real-time position information and the riding route in an electronic map page in an application on the terminal of the ordering person.

In S406, the SER returns the geographical position information of the UE2 or the UE3 to the UE1.

It should be considered that in practical applications, during a travel or after the travel is completed, the server also needs to deal with a problem of paying for the order. Alternatively, the method according to the embodiments of the present application further comprises:

after transmitting the notification message to the UE3, the server transmitting an order payment request to the UE1 and receiving an order payment response returned by the UE1; or

the server transmitting an order payment request to the UE3 and receiving an order payment response returned by the UE3; or

the server transmitting an order payment request to the UE1 and the UE3, respectively, and rejecting to receive an order payment response returned by one of the UE1 and the UE3 when receiving an order payment response returned by the other of the UE1 and the UE3.

With the present embodiment, the order can be paid for not only by the third party user, but also by the ordering user. The order payment request comprises a payment amount, and may comprise information such as a travel mileage, a charge per kilometer etc.

Further, in practical applications, the ordering user may find that there is insufficient balance after ordering for the third party user, and therefore the UE1 corresponding to the ordering user cannot pay to the server, or the ordering user may order for the third party user as the third party user cannot pay for the order due to insufficient balance etc. Therefore, the server is required to flexibly deal with the payment information.

Alternatively, the embodiments of the present application further provide a method for indicating by the UE1 corresponding to the ordering user or the UE3 corresponding to the third party user whether to pay for the order by the UE1 or the UE3. In an implementation, the first order information transmitted by the UE1 comprises, in addition to the riding information, payment indication information for indicating that the UE1 (i.e., the ordering user) or the UE3 (i.e., the third party user) pays for the order.

For example, the SER transmits an order payment request to the UE1 according to the payment indication information indicating payment by the UE1 in the first order information and receives an order payment response returned by the UE1; or transmits an order payment request to the UE3 according to the payment indication information indicating payment by the UE3 in the first order information and receives an order payment response returned by the UE3.

In this way, the UE1 can flexibly indicate whether to pay by the UE1 or the UE3 in the first ordering request.

In addition to the method of the UE1 indicating whether to pay by the UE1 or the UE3 in the first order information, in another implementation, the order confirmation response transmitted by the UE3 further comprises payment indication information indicating payment by the UE1 (i.e., the ordering user) or the UE3 (i.e., the third party user).

For example, the SER transmits an order payment request to the UE1 and receives an order payment response returned by the UE1 according to the order payment information indicating payment by the UE1 in the order confirmation response; or

transmits an order payment request to the UE3 and receives an order payment response returned by the UE3 according to the order payment information indicating payment by the UE3 in the order confirmation response.

In this way, the UE3 can flexibly complete payment indication of whether to pay by the UE1 or the UE3 in the order confirmation response.

This will be described in detail below by way of example of the first order information transmitted by the UE1 comprising payment indication information indicating payment by the UE3 (the third party user).

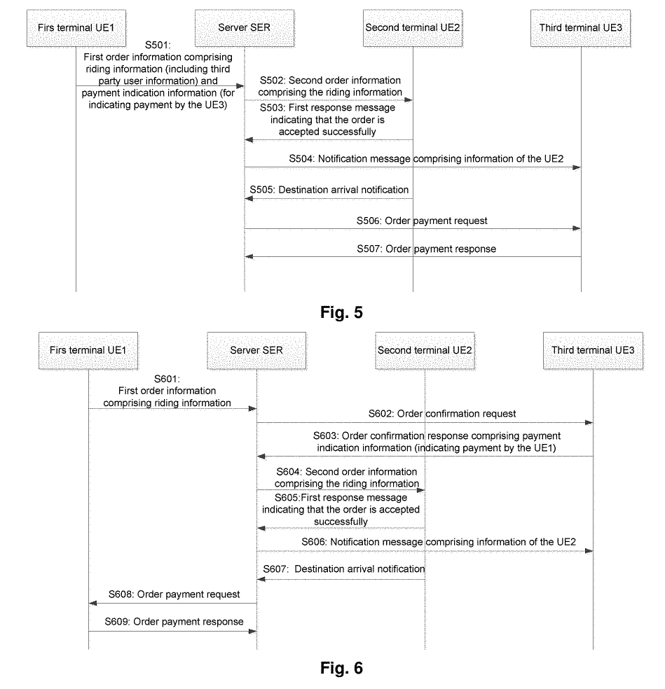

As shown in FIG. 5, a method for processing an order according to an embodiment of the present disclosure comprises the following steps.

In S501, the UE1 transmits first order information to the SER, wherein the first order information comprises riding information including third party user information, and the first order information further comprises payment indication information for indicating that the UE3 pays for the order.

In S502, the SER receives the first order information transmitted by the UE1, and transmits second order information to the UE2, wherein the second order information comprises the riding information, and the second order information further comprises the payment indication information indicating payment by the UE3 (i.e., a third party user).

In S503, the UE2 returns a first response message indicating that the order is accepted successfully to the SER.

In S504, the SER transmits a notification message to the UE3, wherein the notification message comprises information of the UE2.

In S505, the SER acquires a destination arrival notification from the UE3.

In S506, the SER transmits an order payment request to the UE3 according to the order payment information indicating payment by the UE3 in the first order information.

In S507, the UE3 receives the order payment request transmitted by the SER and transmits an order payment response to the SER.

In S506, the order payment request comprises a payment amount, and may further comprise information such as a travel mileage, a charge per kilometer etc.

In S501, the first order information may further comprise payment indication information indicating payment by the UE1 (i.e., an ordering user), and as a result, in S506, the SER transmits an order payment request to the UE1 according to the payment indication information indicating payment by the UE1 in the first order information, and in S507, the UE1 receives the order payment request transmitted by the SER, and transmits an order payment response to the SER.

This will be described in detail below by way of example of the order confirmation response transmitted by the UE3 comprising the payment indication information indicating payment by the UE1 (i.e., the ordering user).

As shown in FIG. 6, a method for processing an order according to an embodiment of the present disclosure comprises the following steps.

In S601, the UE1 transmits first order information to the SER, wherein the first order information comprises riding information including third party user information.

In S602, the SER transmits an order confirmation request to the UE3 according to the riding information including the third party user information in the first order information.

In S603, the UE3 transmits an order confirmation response to the SER, wherein the order confirmation response further comprises payment indication information indicating payment by the UE1 (i.e., an ordering user).

In S604, the SER transmits second order information to the UE2, wherein the second order information comprises the riding information.

In S605, the UE2 returns a first response message indicating that the order is accepted successfully to the SER.

In S606, the SER transmits a notification message to the UE3, wherein the notification message comprises information of the UE2.

In S607, the SER acquires a destination arrival notification from the UE3.

In S608, the SER transmits an order payment request to the UE1 according to the payment indication information indicating payment by the UE1 in the order confirmation response.

In S609, the UE1 receives the order payment request transmitted by the SER and transmits an order payment response to the SER.

In the above steps, the order payment request comprises a payment amount, and may further comprise information such as a travel mileage, a charge per kilometer etc.

In S603, the order confirmation response may further comprise payment indication information indicating payment by the UE3 (i.e., a third party user), and as a result, in S608, the SER transmits an order payment request to the UE3 according to the payment indication information indicating payment by the UE3 in the order confirmation response, and in S609, the UE3 receives the order payment request transmitted by the SER, and transmits an order payment response to the SER.

In addition to that the first order information comprises payment indication information indicating payment by the UE1 in S501 and the order confirmation response comprises payment indication information indicating payment by the UE3 in S603, the payment indication information indicating payment by the UE1 or the UE3 may be included in other communication messages between the UE1 or the UE3 and the SER, and will not be repeated here.

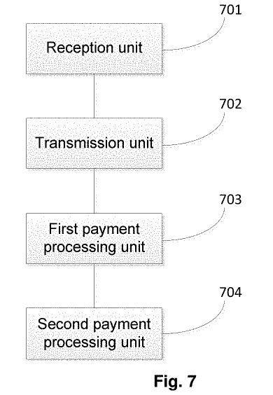

As shown in FIG. 7, a server for processing an order according to an embodiment of the present application comprises:

a reception unit 701 configured to receive first order information transmitted by a first terminal, wherein the first order information comprises riding information including third party user information; and

a transmission unit 702 configured to transmit second order information to a second terminal, wherein the second order information comprises the riding information.

The transmission unit 702 is further configured to transmit a notification message to a third terminal according to the third party user information, and the notification message comprises information of the second terminal.

Alternatively, the transmission unit 702 is further configured to transmit an order confirmation request to the third terminal according to the third party user information; and the reception unit 701 is further configured to receive an order confirmation response returned by the third terminal.

Alternatively, the reception unit 701 is further configured to receive the order confirmation response comprising updated riding information returned by the third terminal.

Alternatively, the transmission unit 702 is further configured to transmit a second notification message to the first terminal after the reception unit 701 receives the order confirmation response returned by the third terminal, wherein the second notification message comprises the information of the second terminal in the notification message transmitted to the third terminal.

Alternatively, the reception unit 701 is further configured to acquire position information of the second terminal and/or the third terminal; and the transmission unit 702 is further configured to transmit the position information to the first terminal.

Alternatively, the server further comprises a first payment processing unit 703 configured to, after the transmission unit 702 transmits the notification message to the third terminal corresponding to a third party user, transmit an order payment request to the first terminal and receive an order payment response returned by the first terminal; or transmit an order payment request to the third terminal and receive an order payment response returned by the third terminal; or transmit an order payment request to the first terminal and the third terminal, respectively, and reject to receive an order payment response returned by one of the first terminal and the third terminal when receiving an order payment response returned by the other of the first terminal and the third terminal.

Alternatively, the reception unit 701 is configured to receive the first order information comprising payment indication information indicating payment by the first terminal (i.e., an ordering user) or the third terminal (i.e., the third party user).

Further, the server further comprises a second payment processing unit 704 configured to, transmit an order payment request to the first terminal and receive an order payment response returned by the first terminal according to the payment indication information indicating payment by the first terminal in the first order information; or transmit an order payment request to the third terminal and receive an order payment response returned by the third terminal according to the payment indication information indicating payment by the third terminal in the first order information.

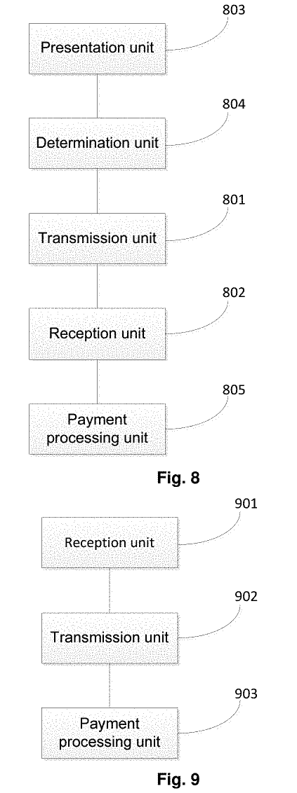

As shown in FIG. 8, a first terminal according to an embodiment of the present application comprises:

a transmission unit 801 configured to transmit first order information to a server, so that the server orders for a third terminal according to third party user information, wherein the first order information comprises riding information including the third party user information; and a reception unit 802 configured to receive a response message returned by the server indicating that the ordering is successful.

Alternatively, the first terminal further comprises: a presentation unit 803 configured to present an ordering page to a user before the transmission unit 801 transmits the first order information to the server, wherein the ordering page comprises promotion information for prompting the user to input riding information. The reception unit 802 is further configured to receive the riding information input by the user on the ordering page.

Further, the first terminal further comprises a determination unit 804 configured to determine whether the input third party user information is consistent with the ordering user information after the reception unit 802 receives the riding information input by the user on the ordering page.

Alternatively, the reception unit 802 is further configured to receive position information of the second terminal and/or the third terminal.

Alternatively, the transmission unit 801 is further configured to transmit the first order information comprising payment indication information indicating payment by the first terminal or the third terminal.

Alternatively, the first terminal further comprises a payment processing unit 805 configured to receive an order payment request transmitted by the server, and transmit an order payment response to the server.

As shown in FIG. 9, a third terminal according to an embodiment of the present application comprises:

a reception unit 901 configured to receive an order confirmation request transmitted by a server according to first order information, wherein the order confirmation request comprises riding information; and

a transmission unit 902 configured to transmit an order confirmation response to the server, so that the server transmits second order information to a second terminal.

The reception unit 901 is further configured to receive a notification message returned by the server indicating that the ordering is successful.

Alternatively, the transmission unit 902 is further configured to transmit an order confirmation response comprising payment indication information indicating payment by the first terminal or the third terminal.

Alternatively, the third terminal further comprises a payment processing unit 903 configured to receive an order payment request transmitted by the server and transmit an order payment response to the server.

Alternatively, the transmission unit 902 is further configured to, after the reception unit 901 receives the notification message returned by the server indicating that the ordering is successful, transmit position information of the third terminal to the first terminal corresponding to an ordering person or the server; or transmit an arrival message indicating that the third terminal arrives at a destination to the first terminal or the third terminal.

The present application is described with reference to the flowcharts and/or block diagrams of the methods, devices (systems) and computer program products according to the embodiments of the present application. It should be understood that each flow and/or block in the flowcharts and/or block diagrams as well as a combination of the flows and/or blocks in the flowcharts and/or block diagrams can be implemented by computer program instructions. These computer program instructions can be provided to a processor of a general-purpose computer, a dedicated-purpose computer, an embedded processor, or other programmable data processing devices to generate a machine. Thereby, the instructions executed by the processor of the computer or other programmable data processing devices generate means for implementing functions specified in one or more flows in the flowcharts and/or one or more blocks in the block diagrams.

These computer program instructions can also be stored in a computer readable memory capable of introducing a computer or other programmable data processing devices to operate in a particular mode. Thereby, the instructions stored in the computer readable memory generate an article of manufacture comprising instruction means for implementing functions specified in one or more flows in the flowcharts and/or one or more blocks in the block diagrams.

These computer program instructions can also be loaded onto a computer or other programmable data processing devices, so as to enable a series of operation steps to be performed on the computer or other programmable devices to generate a computer-implemented process. Thereby, the instructions executed on the computer or other programmable devices provide a step of implementing functions specified in one or more flows in the flowcharts and/or one or more blocks in the block diagrams.

In a typical configuration, a computing device comprises one or more processors (CPUs), an input/output interface, a network interface, and a memory.

The memory may comprise a volatile memory, a Random Access Memory (RAM) and/or a nonvolatile memory such as a Read Only Memory (ROM) or a flash memory (flash RAM) in a computer readable medium. The memory is an example of the computer-readable medium.

Computer-readable media comprise non-volatile and volatile, and removable and non-removable media, which can store information using any method or technology. The information may be computer readable instructions, a data structure, a program module, or other data. Examples of the computer storage media comprise, but are not limited to, Phase Change RAM (PRAM), Static Random Access Memory (SRAM), Dynamic Random Access Memory (DRAM), other types of Random Access Memories (RAMs), Read Only Memory (ROM), Electrically Erasable Programmable Read-Only Memory (EEPROM), flash memory or other memory technology, Compact Disk Read-Only Memory (CD-ROM), Digital Versatile Disc (DVD) or other optical storage, cassette tape, tape magnetic disc storage or other magnetic storage devices, or any other non-transmission medium, and may be used to store information that can be accessed by the computing device. As defined herein, the computer-readable medium does not comprise transitory media, such as a modulated data signal and a carrier.

It is also to be understood that terms “comprising”, “including” or any other variant thereof are intended to encompass a non-exclusive inclusion such that processes, methods, articles or devices including a series of elements include not only those elements but also other elements that are not explicitly listed, or elements that are inherent to such processes, methods, articles, or devices. In the absence of more restrictions, the elements defined by the statement “including a . . . ” do not exclude the presence of additional identical elements in the processes, methods, articles, or devices that include the elements.

It will be appreciated by those skilled in the art that embodiments of the present application can be provided as methods, systems, or computer program products. Accordingly, the present application may take a form of a pure hardware embodiment, a pure software embodiment, or a combination of software and hardware aspects. Moreover, the present application may take a form of a computer program product implemented on one or more computer usable storage media (including but not limited to disk storage, CD-ROM, optical memory, etc.) in which computer usable program codes are included.

The foregoing is merely embodiments of the present application and is not intended to limiting the present application. It will be apparent to those skilled in the art that various changes and modifications can be made in the present application. Any modification, equivalent substitution, improvement etc. within the spirit and principles of the present application is intended to be included within the scope of the claims of the present application.

1. A method for processing an order, comprising:
receiving first order information transmitted by a first terminal, wherein the first order information comprises riding information including third party user information;
transmitting second order information to a second terminal, wherein the second order information comprises the riding information; and
transmitting a notification message to a third terminal according to the third party user information, wherein the notification message comprises information of the second terminal.

2. The method according to claim 1, wherein before transmitting the second order information to the second terminal, the method further comprises:
transmitting an order confirmation request to the third terminal according to the third party user information; and
receiving an order confirmation response returned by the third terminal.

3. The method according to claim 2, wherein the order confirmation response comprises:
updated riding information.

4. The method according to claim 1, wherein the first order information further comprises:
payment indication information for indicating that the first terminal or the third terminal pays for the order.

5. The method according to claim 1, further comprising:
transmitting position information of the second terminal and/or the third terminal to the first terminal.

6. An ordering method, comprising:
transmitting, by a first terminal, first order information to a server, so that the server orders for a third terminal according to third party user information, wherein the first order information comprises riding information including the third party user information; and
receiving a response message returned by the server indicating that the ordering is successful.

7. The method according to claim 6, wherein the first order information further comprises:
payment indication information for indicating that the first terminal or the third terminal pays for an order.

8. An ordering method, comprising:
receiving, by a third terminal, an order confirmation request transmitted by a server according to first order information, wherein the order confirmation request comprises riding information;
transmitting an order confirmation response to the server, so that the server transmits second order information to a second terminal; and
receiving a notification message returned by the server indicating that the ordering is successful.

9. The method according to claim 8, wherein the order confirmation response comprises:
updated riding information.

10. A server for processing an order, comprising:
a reception unit configured to receive first order information transmitted by a first terminal, wherein the first order information comprises riding information including third party user information; and
a transmission unit configured to transmit second order information to a second terminal, wherein the second order information comprises the riding information;
wherein the transmission unit is further configured to transmit a notification message to a third terminal according to the third party user information, wherein the notification message comprises information of the second terminal.

11. The server according to claim 10, wherein
the transmission unit is further configured to transmit an order confirmation request to the third terminal according to the third party user information; and
the reception unit is further configured to receive an order confirmation response returned by the third terminal.

12. The server according to claim 11, wherein
the reception unit is further configured to receive the order confirmation response comprising updated riding information returned by the third terminal.

13. The server according to claim 10, wherein
the reception unit is further configured to receive the first order information comprising payment indication information transmitted by the first terminal; and
the payment indication information is used to indicate that the first terminal or the third terminal pays for the order.

14. The server according to claim 10, wherein
the transmission unit is further configured to transmit position information of the second terminal and/or the third terminal to the first terminal.

15. A first terminal, comprising:
a transmission unit configured to transmit first order information to a server, so that the server orders for a third terminal according to third party user information, wherein the first order information comprises riding information including the third party user information; and
a reception unit configured to receive a response message returned by the server indicating that ordering is successful.

16. The first terminal according to claim 15, wherein
the transmission unit is further configured to transmit the first order information comprising payment indication information to the server; and
the payment indication information is used to indicate that the first terminal or the third terminal pays for an order.

17. A third terminal, comprising:
a reception unit configured to receive an order confirmation request transmitted by a server according to first order information, wherein the order confirmation request comprises riding information; and
a transmission unit configured to transmit an order confirmation response to the server, so that the server transmits second order information to a second terminal;
wherein the reception unit is further configured to receive a notification message returned by the server indicating that the ordering is successful.

18. The third terminal according to claim 17, wherein
the transmission unit is further configured to transmit the order confirmation response comprising updated riding information to the server.

19. A system for processing an order, comprising:
a server;
a first terminal;
a second terminal; and
a third terminal,
wherein:
the first terminal is configured to transmit first order information to the server, wherein the first order information comprises riding information including third party user information,
the server is configured to receive the first order information transmitted by the first terminal; transmit second order information to the second terminal; receive a response message returned by the second terminal indicating that the order is accepted successfully; and transmit a notification message to the third terminal according
to the third party user information, wherein the notification message comprises information of the second terminal,
the third terminal is configured to receive an order confirmation request comprising the riding information transmitted by the server according to the first order information; transmit an order confirmation response to the server that includes updated riding information; and receive a notification message returned by the server indicating that ordering is successful, and
the second terminal is configured to receive the second order information transmitted by the server; and return the response message indicating that the order is accepted successfully to the server, so that the server returns the notification message indicating that the ordering is successful to the third terminal, and
wherein the server transmits the second order information to the second terminal according to the riding information included in the first order information or according to the updated riding information in the order confirmation response transmitted by the third terminal.
